(19) United States
(12) Patent Application Publication
(10) Pub. No.: US 2024/0253486 A1
(43) Pub. Date: Aug. 1, 2024

(54) VEHICLE

(71) Applicant: TOYOTA JIDOSHA KABUSHIKI KAISHA, Toyota-shi (JP)

(72) Inventor: Yuya AOKI, Miyoshi-shi (JP)

(73) Assignee: TOYOTA JIDOSHA KABUSHIKI KAISHA, Toyota-shi (JP)

(21) Appl. No.: 18/392,232

(22) Filed: Dec. 21, 2023

(30) Foreign Application Priority Data
Jan. 30, 2023 (JP) 2023-011655

(51) Int. Cl. B60L 53/16; B60L 53/62; B60L 53/66

(52) U.S. Cl. CPC B60L 53/16; B60L 53/62; B60L 53/66

(57) ABSTRACT

When the external power supply is connected to the connector, the control device determines whether the external power supply is a system power supply or another vehicle, and when the external power supply is the other vehicle, the control device executes a change process of changing a charging setting from a first setting for charging the power storage device using electric power from the system power supply to a default setting or a second setting for charging the power storage device using electric power from the other vehicle, and then executes charging control in which the charger is controlled such that the power storage device is charged, in accordance with the charging setting.

### CROSS-REFERENCE TO RELATED APPLICATION

This application claims priority to Japanese Patent Application No. 2023-011655 filed on Jan. 30, 2023, incorporated herein by reference in its entirety.

### BACKGROUND

### 1. Technical Field

The present disclosure relates to a vehicle.

### 2. Description of Related Art

Conventionally, as this type of technique, there has been proposed a charging device that charges a battery of a vehicle on a power receiving side (vehicle running out of power) with electric power of a battery of a vehicle on a power feeding side (rescue vehicle) (see, for example, Japanese Unexamined Patent Application Publication No. 2016-187256 (JP 2016-187256 A)). In this charging device, charging is started in a first charging mode based on an operation input for starting the charging, and on a condition that the ratio of a battery voltage of the vehicle running out of power to a battery voltage of the rescue vehicle reaches a predetermined value, the first charging mode is ended. A second charging mode is started based on an operation input for restarting the charging. Here, the maximum value of a current value that can be supplied to the vehicle running out of power in the second charging mode is made smaller than in the first charging mode.

### SUMMARY

In a vehicle equipped with a power storage device and a charger capable of charging the power storage device using electric power from a system power supply, a current value, charging start time, etc., may be set for charging of the power storage device using electric power from the system power supply, as a charging setting. In this case, when the vehicle runs out of power, etc., and it is desired to charge the power storage device using electric power from another vehicle, there is a possibility that the charging of the power storage device takes a relatively long time due to the charging setting.

A main object of a vehicle of the present disclosure is to suppress charging from being relatively prolonged when charging of a power storage device using electric power from another vehicle is desired.

The vehicle according to the present disclosure adopts the following means in order to achieve the above-described main object.

The gist of a vehicle of the present disclosure is a vehicle comprising: a power storage device; a connector to which an external power supply is able to be connected directly or via a relay cable portion; a charger that is able to charge the power storage device using electric power from the external power supply, when the external power supply is connected to the connector; and a control device that controls the charger.

When the external power supply is connected to the connector, the control device determines whether the external power supply is a system power supply or another vehicle, and when the external power supply is the other vehicle, the control device executes a change process of changing a charging setting from a first setting for charging the power storage device using electric power from the system power supply to a default setting or a second setting for charging the power storage device using electric power from the other vehicle, and then executes charging control in which the charger is controlled such that the power storage device is charged, in accordance with the charging setting.

In the vehicle of the present disclosure, when the external power supply is connected to the connector, the control device determines whether the external power supply is a system power supply or another vehicle, and when the external power supply is the other vehicle, the control device executes a change process of changing a charging setting from a first setting for charging the power storage device using electric power from the system power supply to a default setting or a second setting for charging the power storage device using electric power from the other vehicle, and then executes charging control in which the charger is controlled such that the power storage device is charged, in accordance with the charging setting. Here, the default setting and the second setting are set so that charging of the power storage device can be completed in a shorter time than the first setting. As a result, when the vehicle (host vehicle) runs out of power, etc., and it is desired to charge the power storage device using electric power from another vehicle, it is possible to suppress charging from being relatively prolonged compared to a case in which the charging setting is maintained at the first setting.

In the vehicle of the present disclosure: the system power supply may output a first signal to the vehicle when connected to the connector; the other vehicle may output a second predetermined signal different from the first signal to the vehicle when connected to the connector; and when the external power supply is connected to the connector, the control device may determine whether the external power supply is the system power supply or the other vehicle, based on which of the first signal and the second signal is input. This makes it possible to appropriately determine whether the external power supply is the system power supply or the other vehicle.

In the vehicle of the present disclosure: the relay cable portion for first charging and the relay cable portion for second charging may have different resistance values at a predetermined portion; and when the external power supply is connected to the connector via the relay cable portion, the control device may determine whether the external power supply is the system power supply or the other vehicle, based on a voltage of the predetermined portion. This makes it possible to appropriately determine whether the external power supply is the system power supply or the other vehicle.

In the vehicle of the present disclosure: in a case in which the external power supply is the other vehicle, when the change process is permitted, the control device may execute the change process, and then execute the charging control in accordance with the charging setting, and when the change process is prohibited, the control device may maintain the charging setting and execute the charging control in accordance with the charging setting; and the control device may switch permission and prohibition of the change process based on an instruction of a user. In this way, it is possible to match the preferences of the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle 10, a charging station 30, and a relay cable portion 40 according to this embodiment;

FIG. 2 is a schematic configuration diagram of the vehicle 10, the other vehicle 50, and the relay cable portion 60;

FIG. 3 is a flowchart showing an example of a processing routine executed by the electronic control unit 20; and

FIG. 4 is a flowchart showing an example of a processing routine executed by the electronic control unit 20.

### DETAILED DESCRIPTION OF EMBODIMENTS

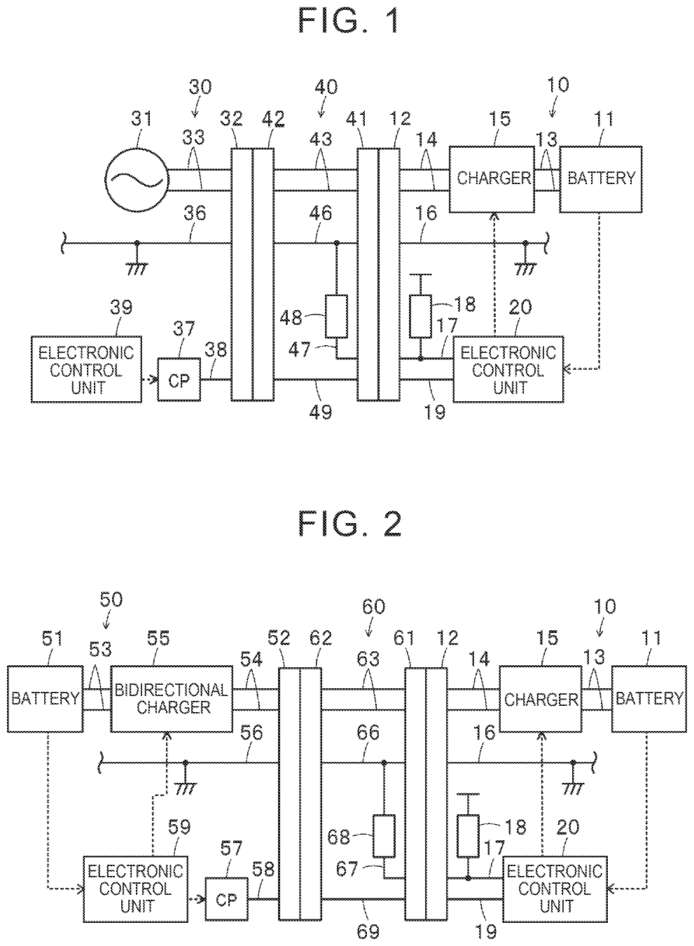

Embodiments of the present disclosure will be described with reference to the drawings. FIG. 1 is a schematic configuration diagram of a vehicle 10, a charging station 30, and a relay cable portion 40 of this embodiment, and FIG. 2 is a schematic configuration diagram of a vehicle 10, another vehicle 50, and a relay cable portion 60. FIG. 1 and FIG. 2, the configuration of the vehicle 10 is the same. Hereinafter, the vehicle 10 (own vehicle), the charging station 30, the relay cable portion 40, the other vehicle 50, and the relay cable portion 60 will be described in this order.

As shown in FIGS. 1 and 2, the vehicle 10 is configured as a battery electric vehicle, and includes a battery 11 as a power storage device, a connector 12 (inlet), a power line 13, a power line 14, and a charger. 15, a ground line 16, a connection line 17, a resistance element 18, a communication line 19 and an electronic control unit 20. Vehicle 10 is connected to charging station 30 via relay cable portion 40 and is connected to another vehicle 50 via relay cable portion 60.

The battery 11 is configured as, for example, a lithium-ion secondary battery or a nickel-hydrogen secondary battery, and is connected to the charger 15 via the power line 13. The connector 12 includes a power line 14 connected to a charger 15, a grounded ground line 16, and a connection connected to an electronic control unit 20 and to a positive reference potential Vcc via a resistance element 18. Line 17 is connected to communication line 19 which is connected to electronic control unit 20. The connector 12 is configured to connect the connector 41 of the relay cable portion 40 and connect the connector 61 of the relay cable portion 60. A resistance element having a resistance value R0 is used as the resistance element 18.

Charger 15 is connected to battery 11 via power line 13 and to connector 12 via power line 14. The charger 15 is configured to convert AC power on the power line 14 into DC power, adjust the voltage, and supply the DC power to the power line 13.

The electronic control unit 20 has a microcomputer, and the microcomputer has a CPU, ROM, RAM, flash memory, input/output ports, and communication ports. The electronic control unit 20 inputs the voltage, current, temperature, etc. of the battery 51 from, for example, a voltage sensor, a current sensor, and a temperature sensor (none of which are shown) attached to the battery 11 via an input port. A connection line 17 connected to the connector 12 and a communication line 19 are connected to the input port of the electronic control unit 20. The electronic control unit 20 calculates the charging ratio of the battery 11 based on the integrated value of the current of the battery 11. The electronic control unit 59 outputs, for example, control signals to the charger 15 through the output port. Electronic control unit 59 communicates with electronic control unit 39 of charging station 30 when vehicle 10 is connected to charging station 30 via relay cable portion 40, and communicates with the electronic control unit 59 of the other vehicle 50 when the vehicle 10 is connected to another vehicle 50 via relay cable portion 60.

Next, the charging station 30 will be described. The charging station 30 is installed at a home, a charging station, or the like, and as shown in FIG. 1, a system power supply 31, a connector 32, a power line 33, a ground line 36, a control pilot circuit 37, a communication line 38, and an electronic control unit 39 are included.

The system power supply 31 is connected to the connector 32 via the power line 33 and also to the power system (not shown), and can supply 100V or 200V AC power from the power system to the power line 33. In addition to the system power supply 31 being connected to the connector 32 via the power line 33, a grounded ground line 36 and a communication line 38 connected to a control pilot circuit 37 are also connected. The connector 32 is configured so that the connector 42 of the relay cable portion 40 can be connected. The control pilot circuit 37 has an oscillation circuit (not shown), and converts a signal from the oscillation circuit into a control pilot signal having a duty D1 and a frequency f1 according to a control signal from the electronic control unit 39, and transmits the signal to a communication line. 38.

The electronic control unit 39 has a microcomputer, and the microcomputer has a CPU, ROM, RAM, flash memory, input/output ports, and communication ports. The electronic control unit 39 outputs, for example, a control signal to the control pilot circuit 37 through an output port. Electronic control unit 39 communicates with electronic control unit 20 of vehicle 10 when vehicle 10 is connected to charging station 30 via relay cable portion 40.

Next, the relay cable portion 40 will be described. The relay cable portion 40 is configured as a cable portion used for relaying between the vehicle 10 and the charging station 30, and includes a connector 41, a connector 42, a power line 43, a ground line 46, a connection line 47, and a resistor. It comprises a resistance element 48 and a communication line 49.

A power line 43, a ground line 46, a connection line 47 connected to the ground line 46 via a resistance element 48, and a communication line 49 are connected to the connector 41. Connector 41 is configured to be connectable with connector 12 of vehicle 10. A resistance element having a resistance value R1 is used as the resistance element 48. A power line 43, a ground line 46 and a communication line 49 are connected to the connector 42. Connector 42 is configured to be connectable with connector 32 of charging station 30.

When the connector 41 of the relay cable portion 40 is connected to the connector 12 of the vehicle 10 and the connector 42 of the relay cable portion 40 is connected to the connector 32 of the charging station 30, the power line 14 of the vehicle 10 and the power line 33 of the charging station 30 are connected via the power line 43 of the relay cable portion 40. Also, the ground line 16 of the vehicle 10 and the ground line 36 of the charging station 30 are connected via the ground line 46 of the relay cable portion 40. Furthermore, the communication line 19 of the vehicle 10 and the communication line 38 of the charging station 30 are connected via the communication line 49 of the relay cable portion 40. As a result, the electronic control unit 20 receives the control pilot signal (signal of duty D1 and frequency f1) from the control pilot circuit 37. The connection line 17 of the vehicle 10 and the connection line 47 of the relay cable portion 40 are also connected. Thereby, the reference potential Vcc and the ground line 46 are connected via the resistance element 18, the connection line 17, the connection line 47 and the resistance element 48. Therefore, the potential of the connection line 17 is the product of the reference potential Vcc and the ratio of the resistance value R1 of the resistance element 48 to the sum of the resistance value R0 of the resistance element 18 and the resistance value R1 of the resistance element 48 (Vcc×R1/(R0+R1)).

Next, the other vehicle 50 will be explained. The other vehicle 50 is configured as a battery electric vehicle, a hybrid electric vehicle, or a fuel cell electric vehicle capable of supplying power to the outside of the vehicle, and as shown in FIG. 2, is equipped with a battery 51 as a power storage device, a connector 52 (an inlet), a power line 53, a power line 54, a bidirectional charger 55, a ground line 56, a control pilot circuit 57, a communication line 58 and an electronic control unit 59.

The battery 51 is configured similarly to the battery 11 of the vehicle 10. A power line 54 connected to a bidirectional charger 55, a grounded ground line 56, and a communication line 58 connected to the control pilot circuit 37 are connected to the connector 52. The connector 52 is configured so that the connector 62 of the relay cable portion 60 can be connected.

Bidirectional charger 55 is connected to battery 51 via power line 53 and to connector 52 via power line 54. The bidirectional charger 55 converts the AC power on the power line 54 into DC power, further adjusts the voltage, and supplies it to the power line 53, or adjusts the voltage of the DC power on the power line 53 to further convert it into AC power, and supplies it to the power line 54. The control pilot circuit 57 has an oscillation circuit similarly to the control pilot circuit 37 of the charging station 30, and the signal from the oscillation circuit is changed to the duty D2 and the frequency f2 by the control signal from the electronic control unit 59. It converts it into a control pilot signal and outputs it to the communication line 58. Duty D2 and frequency f2 are different from duty D1 and frequency f1 of the control pilot signal output by control pilot circuit 37 of charging station 30.

The electronic control unit 59 has a microcomputer, and the microcomputer has a CPU, ROM, RAM, flash memory, input/output ports, and communication ports. The electronic control unit 59 inputs the voltage, current, temperature, etc. of the battery 51 from, for example, a voltage sensor, a current sensor, and a temperature sensor (none of which are shown) attached to the battery 51 via an input port. The electronic control unit 59 calculates the charging ratio of the battery 51 based on the integrated value of the current of the battery 51. The electronic control unit 59 outputs, for example, a control signal to the bidirectional charger 55, a control signal to the control pilot circuit 57, and the like through the output port. Electronic control unit 59 communicates with electronic control unit 20 of vehicle 10 when vehicle 10 is connected to other vehicle 50 via relay cable portion 60.

Next, the relay cable portion 60 will be described. The relay cable portion 60 is configured as a cable portion used for relaying between the vehicle 10 and the other vehicle 50, and includes a connector 61, a connector 62, a power line 63, a ground line 66, a connection line 67, and a resistor. It comprises a resistance element 68 and a communication line 69.

A power line 63, a ground line 66, a connection line 67 connected to the ground line 66 via a resistance element 68, and a communication line 69 are connected to the connector 61. Connector 61 is configured to be connectable with connector 12 of vehicle 10. As the resistance element 68, a resistance element having a resistance value R2 different from the resistance value R1 of the resistance element 48 of the relay cable portion 40 is used. A power line 63, a ground line 66 and a communication line 69 are connected to the connector 42. Connector 62 is configured to be connectable with connector 52 of other vehicle 50.

When the connector 61 of the relay cable portion 60 is connected to the connector 12 of the vehicle 10 and the connector 62 of the relay cable portion 60 is connected to the connector 52 of the other vehicle 50, the power line 14 of the vehicle 10 and the power line 53 of the other vehicle 50 are connected via a power line 63 of the relay cable portion 60. Ground line 16 of vehicle 10 and ground line 56 of other vehicle 50 are connected via ground line 66 of relay cable portion 60. Furthermore, the communication line 19 of the vehicle 10 and the communication line 58 of the other vehicle 50 are connected via the communication line 69 of the relay cable portion 60. As a result, the electronic control unit 20 receives the control pilot signal (signal of duty D2 and frequency f2) from the control pilot circuit 57. The connection line 17 of the vehicle 10 and the connection line 67 of the relay cable portion 60 are also connected. As a result, the reference potential Vcc and the ground line 66 are connected via the resistance element 18, the connection line 17, the connection line 67 and the resistance element 68. Therefore, the potential of the connection line 17 is the product of the reference potential Vcc and the ratio of the resistance value R2 of the resistance element 68 to the sum of the resistance value R0 of the resistance element 18 and the resistance value R2 of the resistance element 68 (Vcc×R2/(R0+R2)).

Next, the operation of the vehicle 10 configured in this way, in particular, the operation during external charging in which the battery 11 of the vehicle 10 is charged using electric power from an external power source will be described. Examples of the external power supply include the system power supply 31 of the charging station 30 as shown in FIG. 1 and the other vehicle 50 as shown in FIG. 2. When the other vehicle 50 is configured as a battery electric vehicle, the power from the battery 51 is used as the power from the external power supply. However, when the other vehicle 50 is configured as a hybrid electric vehicle having an engine and a motor, the power from the engine may be used instead of or in addition to the power from the battery 51 as the power from the external power source to generate power from the motor. Further, when the other vehicle 50 is configured as a fuel cell electric vehicle provided with a fuel cell, as electric power from the external power supply, the power generated by the fuel cell may be used instead of or in addition to the electric power from the battery 51. Hereinafter, charging of the battery 11 using power from the system power supply 31 will be referred to as “system power supply”, and charging of the battery 11 using power from the other vehicle 50 will be referred to as “relief charging”. Relief charging is generally performed when vehicle 10 runs out of electricity.

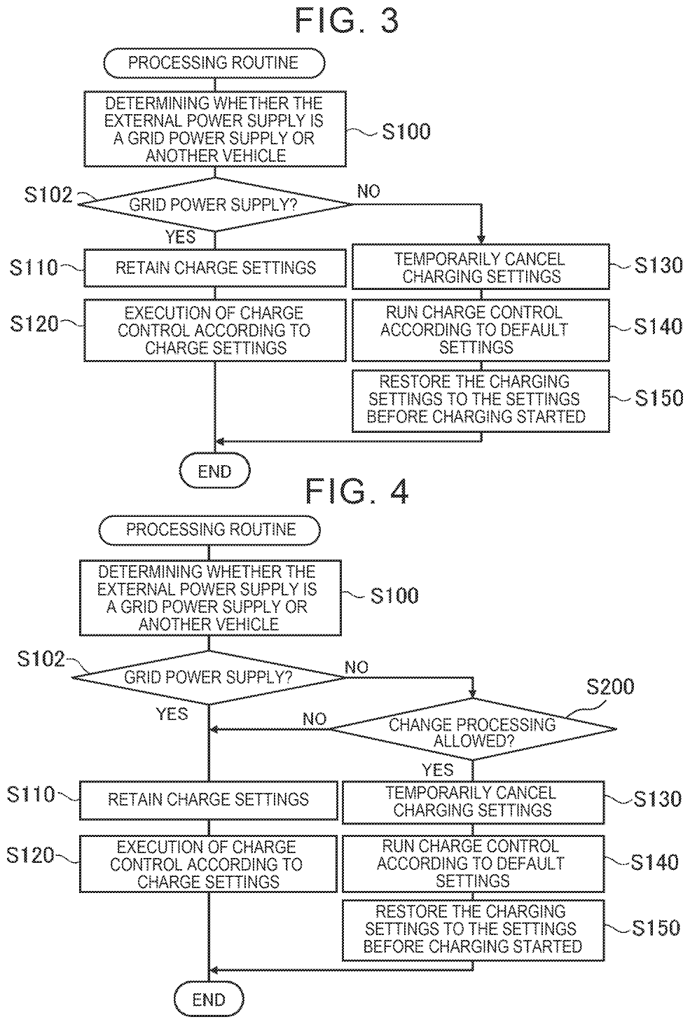

FIG. 3 is a flowchart showing an example of a processing routine executed by the electronic control unit 20 of the vehicle 10. This routine is executed when the charging station 30 is connected to the vehicle 10 via the relay cable portion 40 for system charging, or when another vehicle 50 is connected to the vehicle 10 via the relay cable portion 60 for rescue charging. A case where the first setting for system charging is set as the charging setting for external charging will be described. The first setting includes, for example, the charging start time when charging the battery 11 using the power from the charging station 30 at home, and the target current that is the target value of the charging current for external charging. For example, the charging start time is set so as to charge the battery 11 during times when the electricity rate is low, or a relatively small amount of power is set to the target current in order to suppress the temperature rise of the battery 11, the power line 13, the charger 15, and the like.

When the processing routine of FIG. 3 is executed, the electronic control unit 20 of the vehicle 10 first determines whether the external power supply is the system power supply 31 or the other vehicle 50 (S100, S102). As described above, when charging station 30 is connected to vehicle 10 via relay cable portion 40, electronic control unit 20 receives a control pilot signal (signal of duty D1 and frequency f1) from control pilot circuit 37. At the same time, the potential of the connection line 17 connected to the electronic control unit 70 becomes the potential (Vcc×R1/(R0+R1)). Further, when the other vehicle 50 is connected to the vehicle 10 via the relay cable portion 60, a control pilot signal (signal of duty D2 and frequency f2) from the control pilot circuit 57 is input to the electronic control unit 20. The potential of the connection line 17 becomes the potential (Vcc×R2/(R0+R2)). Further, the duty D1 and the duty D2 are different, the frequency f1 and the frequency f2 are different, and the resistance value R1 and the resistance value R2 are different. Therefore, by checking the duty and frequency of the control pilot signal input to the electronic control unit 70 and checking the potential of the connection line 17 connected to the electronic control unit 70, it is possible to determine whether the external power source is the system power supply 31 or the other vehicle 50.

When it is determined in S100 and S102 that the external power supply is the system power supply 31, the charging setting is held at the first setting (S110), and the battery 11 is charged by executing charging control according to the charging setting (first setting). (S120), and the routine ends. Here, the charging control (charging of the battery 11) is started when a charging start condition is satisfied, and terminated when a charging end condition is satisfied, such as when the charging rate of the battery 11 reaches a target rate. In the charging control, the charger 15 is controlled so that the AC power of the power line 14 is converted into the DC power of the target current and supplied to the power line 13. When the charging setting is the first setting, as the charging start condition, if the external power supply is the system power supply 31 of the charging station 30 at home, the condition that the user instructs to start charging, or the charging start time set in the first setting. In the case where the condition reached is used and the external power supply is the system power supply 31 of the charging station 30 of the charging station, the condition under which the charging start is instructed by the user is used. Also, the value of the first setting is used as the target current for charging control.

When it is determined in S100 and S102 that the external power supply is the other vehicle 50, the first charging setting is temporarily canceled, specifically, the charging setting is changed from the first setting to the default setting (S130). Subsequently, the battery 11 is charged by executing charging control according to the charging setting (default setting) (S140). The start timing and end timing of the charging control (charging of the battery 11) and the method of controlling the charger 15 in the charging control have been described above. The default setting is set so that charging of the battery 11 can be completed in a shorter time than the first setting. For example, the setting of the charging start time is prohibited and the target current is set to a relatively large value (for example, a permissible upper limit). Therefore, when the charging setting is the default setting, the condition under which the charging start is instructed by the user is used as the charging start condition, and a relatively large value is used as the target current for charging control. Since the rescue charging is generally performed when the vehicle 10 runs out of electricity, it is required that the charging of the battery 11 be completed in a relatively short time. If the charging setting is held at the first setting and charging control is executed according to the charging setting, there is a possibility that the charging of the battery 11 will take a relatively long time. On the other hand, by changing the charging setting from the first setting to the default setting and executing charging control according to the charging setting, it is possible to suppress the charging of the battery 11 from being relatively prolonged. After the charging of the battery 11 is completed, the charging setting is restored from the default setting to the setting (first setting) before the start of charging (S150), and this routine ends.

In the vehicle 10 of the present embodiment described above, when the charging station 30 is connected to the vehicle 10 via the relay cable portion 40 or the other vehicle 50 is connected via the relay cable portion 60, the electronic control unit 70 It is determined whether the external power supply is the system power supply 31 or the other vehicle 50. Then, when the external power source is the other vehicle 50, the charging setting is changed from the first setting to the default setting, and charging control is executed according to the charging setting (default setting). As a result, the charging of the battery 11 is relatively prolonged compared to the case where the charging setting is maintained at the first setting and the charging control is executed according to the charging setting (first setting) when the rescue charging is desired. You can suppress it from collapsing.

Further, in the vehicle 10 of the present embodiment, when the charging station 30 is connected to the vehicle 10 via the relay cable portion 40, the control pilot signal from the control pilot circuit 37 (signal of duty D1 and frequency f1) is input to the electronic control unit 20, and the potential of the connection line 17 connected to the electronic control unit 70 becomes the potential (Vcc×R1/(R0+R1)). Further, when the other vehicle 50 is connected to the vehicle 10 via the relay cable portion 60, a control pilot signal (signal of duty D2 and frequency f2) from the control pilot circuit 57 is input to the electronic control unit 20. The potential of the connection line 17 becomes the potential (Vcc×R2/(R0+R2)). Therefore, based on the duty and frequency of the control pilot signal input to electronic control unit 70 and the potential of connection line 17 connected to electronic control unit 70, the external power supply is system power supply 31 or other vehicle 50. It is possible to determine whether

In the above-described embodiment, the electronic control unit 70 changes to the electronic control unit 70 when the charging station 30 is connected to the vehicle 10 via the relay cable portion 40 or the other vehicle 50 is connected via the relay cable portion 60. Based on the duty and frequency of the input control pilot signal and the potential of the connection line 17 connected to the electronic control unit 70, it is determined whether the external power supply is the system power supply 31 of the charging station 30 or the other vehicle 50. I decided to judge. However, whether the external power source is system power supply 31 or other vehicle 50 may be determined based on only part of the duty of the control pilot signal, the frequency of the control pilot signal, and the potential of connection line 17. When the duty of the control pilot signal is not used, the duties D1 and D2 of the control pilot signals from the control pilot circuits 37 and 57 may be the same. If the frequency of the control pilot signal is not used, the frequencies f1 and f2 of the control pilot signals from the control pilot circuits 37 and 57 may be the same. If the potential of the connection line 17 is not used, the resistance values R1 and R2 of the resistance elements 48 and 68 may be the same.

In the embodiment described above, when charging station 30 is connected to vehicle 10 via relay cable portion 40, the control pilot signal from control pilot circuit 37 is input to electronic control unit 20. Also, when another vehicle 50 is connected to the vehicle 10 via the relay cable portion 60, a control pilot signal from the control pilot circuit 57 is input to the electronic control unit 20. However, since it is sufficient for the electronic control unit 20 to distinguish between the control pilot signal from the control pilot circuit 37 and the control pilot signal from the control pilot circuit 57, one of the control pilot signals from the control pilot circuits 37 and 57 may be a signal with superimposed harmonics and the other may be a signal without superimposed harmonics.

In the embodiment described above, the electronic control unit 70 of the vehicle 10 changes the charging setting from the first setting to the default setting when the external power source is the other vehicle 50, and executes charging control according to the charging setting (default setting). However, instead of this, the charging setting may be changed from the first setting for system charging to the second setting for relief charging, and charging control may be executed according to the charging setting (second setting). The second setting is a setting in which at least part of the default setting has been changed by the user, and is set so that charging of the battery 11 can be completed in a shorter time than the first setting, similar to the default setting.

In the embodiment described above, the electronic control unit 70 of the vehicle 10 executes the processing routine of FIG. 3. However, instead of this, the processing routine of FIG. 4 maybe executed. The processing routine of FIG. 4 is the same as the processing routine of FIG. 3 except that the processing of S200 is added. The processing routines of FIG. 4 that are the same as those in the processing routines of FIG. 3 are denoted by the same step numbers, and detailed description thereof will be omitted. In this case, it is assumed that the user operates the vehicle 10 display (not shown) or operates an application on a mobile terminal such as a smartphone or a tablet terminal to set the charging setting during the rescue charging. It is possible to select whether or not to allow the change processing (processing of S130) for changing from the first setting to the default setting.

In the processing routine of FIG. 4, when the electronic control unit 70 of the vehicle 10 determines in S100 and S102 that the external power supply is the other vehicle 50, it determines whether the change processing is permitted or prohibited by the user (S200). When it is determined in S200 that the user permits the change processing, the processing from S130 onwards is executed. That is, the charging setting is changed from the first setting to the default setting, the battery 11 is charged by executing charging control according to the charging setting (default setting), and after the charging of the battery 11 is completed, the charging setting is changed from the default setting. Restores the setting before the start (first setting). When it is determined in S200 that the change processing is prohibited by the user, the processing from S110 onwards is executed. That is, the battery 11 is charged by holding the charging setting at the first setting and executing charging control according to the charging setting (first setting). By doing so, it is possible to match the preferences of the user.

In the embodiment described above, the vehicle 10 is connected to the charging station 30 via the relay cable portion 40 and to the other vehicle 50 via the relay cable portion 60. However, the connector 12 of the vehicle 10 and the connector 32 of the charging station 30 maybe configured so that the vehicle 10 and the charging station 30 can be directly connected without the relay cable portion 40.

In the embodiment described above, a battery is used as the power storage device of the vehicle 10. However, a capacitor may be used as the power storage device.

In the embodiment described above, the vehicle 10 is configured as a battery electric vehicle. However, it may also be configured as a hybrid electric vehicle or a fuel cell electric vehicle. When the vehicle 10 is a hybrid electric vehicle and the engine runs out of fuel and the electricity runs out, or when the vehicle 10 is a fuel cell electric vehicle and the fuel cell runs out of fuel and the electricity runs out, the vehicle 10 is a battery electric vehicle. Therefore, it is conceivable that there may be a case where a rescue charge is required, as in the case of a lack of electricity.

The correspondence relationship between the main elements of the embodiments and the main elements of the disclosure described in the column of Means for Solving the Problems will be described. In the embodiment, the battery 11 corresponds to the “power storage device”, the connector 12 corresponds to the “connector”, the charger 15 corresponds to the “charger”, and the electronic control unit 20 corresponds to the “control device”.

Note that the correspondence relationship between the main elements of the embodiment and the main elements of the disclosure described in the column of Means for Solving the Problem indicates that the embodiment implements the disclosure described in the column of Means to Solve the Problem. Since it is an example for specifically explaining the mode for solving the problem, it does not limit the elements of the disclosure described in the column of the means for solving the problem. That is, the interpretation of the disclosure described in the column of Means to Solve the Problem should be made based on the description in that column, and the embodiment should be based on the description of the disclosure described in the column of Means to Solve the Problem. This is only a specific example.

Although the embodiments for carrying out the present disclosure have been described above, the present disclosure is not limited to such embodiments in any way, and can be implemented in various forms without departing from the gist of the present disclosure.

The present disclosure is applicable to the vehicle manufacturing industry and the like.

What is claimed is:

1. A vehicle comprising:
a power storage device;
a connector to which an external power supply is able to be connected directly or via a relay cable portion;
a charger that is able to charge the power storage device using electric power from the external power supply, when the external power supply is connected to the connector; and
a control device that controls the charger, wherein when the external power supply is connected to the connector, the control device determines whether the external power supply is a system power supply or another vehicle, and when the external power supply is the other vehicle, the control device executes a change process of changing a charging setting from a first setting for charging the power storage device using electric power from the system power supply to a default setting or a second setting for charging the power storage device using electric power from the other vehicle, and then executes charging control in which the charger is controlled such that the power storage device is charged, in accordance with the charging setting.

2. The vehicle according to claim 1, wherein:
the system power supply outputs a first signal to the vehicle when connected to the connector;
the other vehicle outputs a second predetermined signal different from the first signal to the vehicle when connected to the connector; and
when the external power supply is connected to the connector, the control device determines whether the external power supply is the system power supply or the other vehicle, based on which of the first signal and the second signal is input.

3. The vehicle according to claim 1, wherein:
the relay cable portion for first charging and the relay cable portion for second charging have different resistance values at a predetermined portion; and
when the external power supply is connected to the connector via the relay cable portion, the control device determines whether the external power supply is the system power supply or the other vehicle, based on a voltage of the predetermined portion.

4. The vehicle according to claim 1, wherein:
in a case in which the external power supply is the other vehicle, when the change process is permitted, the control device executes the change process, and then executes the charging control in accordance with the charging setting, and when the change process is prohibited, the control device maintains the charging setting and executes the charging control in accordance with the charging setting; and
the control device switches permission and prohibition of the change process based on an instruction of a user.
